(19) United States
(12) Patent Application Publication
(10) Pub. No.: US 2024/0283009 A1
(43) Pub. Date: Aug. 22, 2024

(54) SULFIDE ELECTROLYTE LAYER SUPPORTED DRY PROCESS ELECTRODE LAYER

(71) Applicant: GM GLOBAL TECHNOLOGY OPERATIONS LLC, Detroit, MI (US)

(72) Inventors: Qili SU, Shanghai (CN); Zhe Li, Shanghai (CN); Meiyuan Wu, Shanghai (CN); Dave G. Rich, Sterling Heights, MI (US); Yong Lu, Shanghai (CN); Haijing Liu, Shanghai (CN); Mark W. Verbrugge, Sonoma, CA (US)

(21) Appl. No.: 18/359,466

(22) Filed: Jul. 26, 2023

(30) Foreign Application Priority Data
Feb. 16, 2023 (CN) 202310179184.1

(51) Int. Cl. H01M 10/0562; H01M 4/04; H01M 4/62

(52) U.S. Cl. CPC H01M 10/0562; H01M 4/0435; H01M 4/623; H01M 4/625

(57) ABSTRACT

A method for preparing an electrolyte layer supported by a dry process electrode layer, the method includes providing a sulfide electrolyte layer; providing a first dry process electrode layer; arranging a first side of the sulfide electrolyte layer adjacent to a first side of the first dry process electrode layer; and calendaring the sulfide electrolyte layer and the first dry process electrode layer to reduce a thickness of the sulfide electrolyte layer to a predetermined thickness in a range from approximately 5 micrometers (μm) to approximately 50 μm.

### CROSS-REFERENCE TO RELATED APPLICATIONS

This application claims the benefit of Chinese Patent Application No. 202310179184.1, filed on Feb. 16, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a sulfide-based electrolyte layer supported by a dry process electrode layer.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and discharging of the battery system during charging and/or driving. Manufacturers of EVs are pursuing increased power density to increase the range of the EVs.

Solid-state batteries (SSBs) with solid electrolyte and SSBs with sulfide electrolyte have the potential to be superior to lithium-ion batteries (LIBs) in terms of abuse tolerance, working temperature range and system design.

### SUMMARY

A method for preparing an electrolyte layer supported by a dry process electrode layer, the method includes providing a sulfide electrolyte layer; providing a first dry process electrode layer; arranging a first side of the sulfide electrolyte layer adjacent to a first side of the first dry process electrode layer; and calendaring the sulfide electrolyte layer and the first dry process electrode layer to reduce a thickness of the sulfide electrolyte layer to a predetermined thickness in a range from approximately 5 micrometers (μm) to approximately 50 μm.

In other features, providing the sulfide electrolyte layer comprises preparing a mixture of a sulfide electrolyte and polytetrafluoroethylene (PTFE) binder to create the sulfide electrolyte layer; and calendaring the mixture one or more times to reduce a thickness of the sulfide electrolyte layer.

In other features, the sulfide electrolyte comprises 90 wt % to 99.9 wt % and the PTFE binder comprises 0.1 wt % to 10 wt % of the sulfide electrolyte layer. Providing the first dry process electrode layer comprises preparing a mixture of a sulfide electrolyte, active material, a conductive additive, and PTFE binder to create the sulfide electrolyte layer; and calendaring the mixture one or more times to reduce a thickness of the first dry process electrode layer.

In other features, the sulfide electrolyte comprises 10 wt % to 30 wt %, the active material comprises 50 wt % to 90 wt %, the conductive additive comprises 0 wt % to 10 wt %, and the PTFE binder comprises greater than 0 wt % and less than or equal to 10 wt % of the dry process electrode layer. The active material comprises cathode active material. The method of claim 6, wherein the cathode active material is selected from a group consisting of rock salt layered oxide, spinel, a polyanion cathode material, lithium transition-metal oxides, and lithiated metal oxide/sulfide.

In other features, the active material comprises anode active material. The anode active material is selected from a group consisting of carbonaceous material, silicon, silicon and graphite, Li4Ti5O12, a transition-metal, metal oxide/sulfide, Li metal, and Li alloy. The sulfide electrolyte is selected from a group consisting of pseudobinary sulfide, pseudoternary sulfide, pseudoquaternary sulfide, halide-based solid electrolyte, and hydride-based solid electrolyte. The conductive additive is selected from a group consisting of carbon black, graphite, graphene, graphene oxide, Super P, acetylene black, carbon nanofibers, and carbon nanotubes.

In other features, prior to calendaring, the method includes arranging a second dry process electrode layer adjacent to a second side of the sulfide electrolyte layer. The first dry process electrode layer comprises a cathode electrode layer. The second dry process electrode layer comprises an anode electrode layer.

In other features, the method includes attaching the sulfide electrolyte layer and the first dry process electrode layer to a current collector using an electrically conductive adhesive. The electrically conductive adhesive comprises a polymer and an electrically conductive filler. The polymer is selected from a group consisting of epoxy, polyimide, polyester, vinyl ester, polyvinylidene fluoride (PVDF), polyamide, silicone, and acrylic. The conductive filler is selected from a group consisting of Super P, carbon black, graphene, carbon nanotubes, carbon nanofibers, and metal powder.

In other features, a second side of the sulfide electrolyte layer is arranged on a substrate. The substrate comprises polyethylene terephthalate (PET). The method includes attaching one side of a first one of the first dry process electrode layer and the sulfide electrolyte layer to a first side of a current collector using an electrically conductive adhesive. The method includes attaching one side of a second one of the first dry process electrode layer and the sulfide electrolyte layer to a second side of the current collector using an electrically conductive adhesive.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of a PTFE-based solid electrolyte layer and a dry process electrode layer according to the present disclosure;

FIG. 2A is a side cross-sectional view of a PTFE-based sulfide electrolyte layer according to the present disclosure;

FIG. 2B is a side cross-sectional view of a dry process electrode according to the present disclosure;

FIG. 3 illustrates a method for calendaring the PTFE-based sulfide electrolyte layer and the dry process electrode according to the present disclosure;

FIG. 4 illustrates a method for preparing the PTFE-based sulfide electrolyte layer according to the present disclosure;

FIG. 5 illustrates a method for preparing the dry process cathode electrode according to the present disclosure;

FIG. 6 illustrates a method for calendaring the PTFE-based sulfide electrolyte layer and the dry process cathode electrode using multiple steps according to the present disclosure;

FIG. 7A illustrates a method for calendaring a solid electrolyte layer supported by a dry process anode electrode layer using multiple steps according to the present disclosure;

FIG. 7B is a side cross sectional view including an example of a dry process anode electrode layer including solid electrolyte, anode active material, and PTFE binder according to the present disclosure;

FIG. 8 illustrates a method for calendaring the PTFE-based sulfide electrolyte layer arranged between dry process electrodes according to the present disclosure;

FIG. 9 illustrates a method for calendaring the PTFE-based sulfide electrolyte layer and a dry cathode membrane supported on a substrate according to the present disclosure; and

FIGS. 10A and 10B are side cross-sectional views of single and double-sided electrodes according to the present disclosure.

In the drawings, reference numbers may be reused to identify similar and/or identical elements.

### DETAILED DESCRIPTION

While the battery cells are described herein in the context of EVs, the battery cells can be used in stationary applications, non-vehicle applications, and in other applications.

Sulfide electrolyte film may be prepared using a dry process sulfide electrolyte powder. The sulfide electrolyte film prepared in this manner typically has a thickness in a range from 500 micrometers (μm) to 1000 μm. While ensuring long-term cycling ability, the thickness of the sulfide electrolyte film decreases energy density and power capability.

When using a wet slurry process for the sulfide electrolyte film, the thickness can be reduced to 65 μm (e.g., using Li₆PS₅Cl powder, polyethylene oxide (PEO) binder, LiClO₄ and SiO₂). Although the PEO binder helps to form the sulfide electrolyte film, mechanical imperfections or failures occur due its limited bonding effect. Breakage of sulfide electrolyte film may occur when microstructural defects or voids are formed during cold-pressing.

Free-standing sulfide-based electrolyte membranes can be produced by multiple calendaring steps with a decreasing gap. The sulfide electrolyte film has good film forming properties and a high film elongate rate due to the fibrillating polymer. However, further reducing the thickness of electrolyte membrane to less than 50 μm by calendaring may provide poor efficiency since an angle α of the rollers is close to zero as the thickness of the film is reduced. A resulting ultra-thin free-standing membrane may be fragile and be very hard to handle.

In some examples, a thin sulfide electrolyte layer (approximately 5 μm to 50 μm, e.g., approximately 25.8 μm where the term approximately means +/−10%) according to the present disclosure is achieved by a roll-to-roll calendaring of electrode dry film and sulfide electrolyte dry film. Polytetrafluoroethylene (PTFE) binder in an electrode film and a sulfide electrolyte layer may provide good film forming properties and a high film elongation rate due to the fibrillating nature of the PTFE. With the help of the supportive dry electrode layer, the thickness of the sulfide electrolyte layer can be reduced. The thin sulfide electrolyte membrane provides an effective strategy for constructing a high-power solid-state battery.

In some examples, a thin PTFE-based sulfide electrolyte layer (e.g., less than 30 μm) can be achieved by roll-to-roll calendaring with the help of the supportive dry cathode membrane as described herein, which increases energy density of the resulting solid-state battery. The dual layer structure shows good mechanical strength.

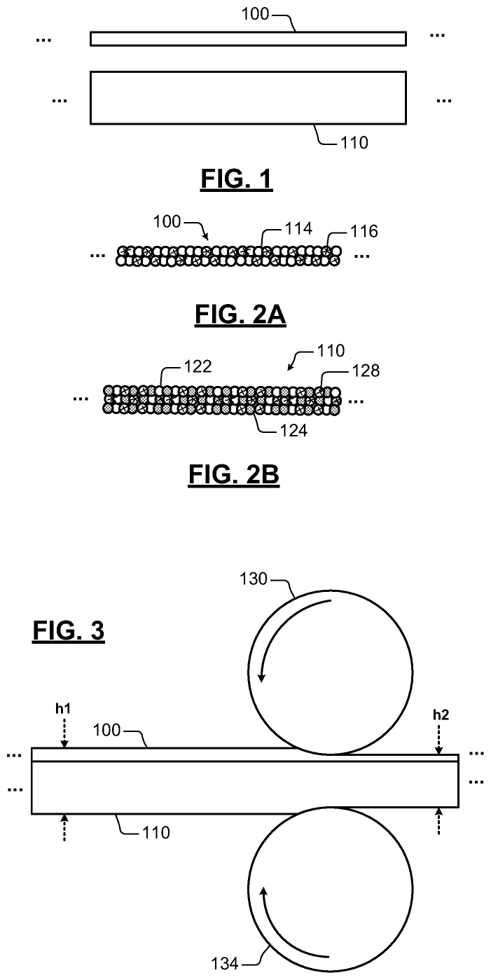

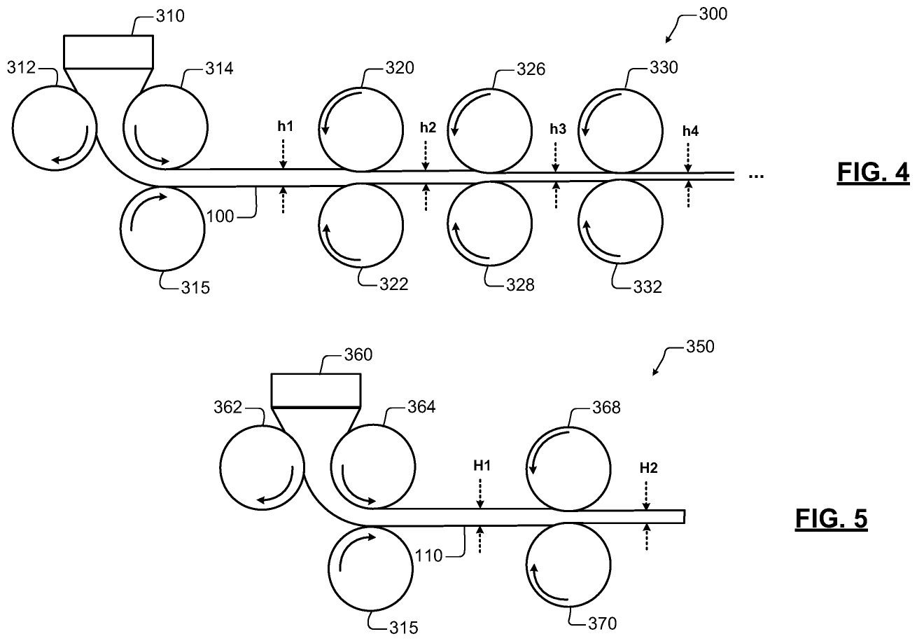

Referring now to FIGS. 1, 2A, and 2B, a PTFE-based sulfide electrolyte layer 100 and a dry process cathode electrode layer 110 are shown. In FIG. 2A, the PTFE-based sulfide electrolyte layer 100 includes a mixture of sulfide electrolyte 114 and PTFE fibrils 116. In FIG. 2B, the dry process cathode electrode layer 110 includes a mixture of cathode active material 122, sulfide electrolyte 128, and PTFE fibrils 124.

Referring now to FIG. 3, a method for calendaring the PTFE-based sulfide electrolyte layer (e.g., 100) and the dry process electrode layer (e.g., 110) is shown. The PTFE-based sulfide electrolyte layer 100 is arranged in contact with the dry process electrode 110, and the laminate (combination of 100 and 110) is compressed by rollers 130 and 134. The combination has an initial height h1 that is reduced to a height h2 via the rollers 130 and 134.

The PTFE-based sulfide electrolyte layer 100 increases favorable ion transfer between the cathode and anode electrodes. In some examples, the PTFE-based sulfide electrolyte layer 100 has a thickness in a range from approximately 2 μm to approximately 30 μm (e.g., approximately 20 μm). In some examples, the PTFE-based sulfide electrolyte layer 100 includes or consists of sulfide electrolyte and a PTFE binder. In some examples, the sulfide electrolyte includes approximately 90 wt % to 99.9 wt %, and the PTFE binder includes approximately 0.1 wt % to 10 wt %, e.g., <2 wt %). In various implementations, the sum of wt % of the sulfide electrolyte and the PTFE binder equals 100 wt %.

The dry process cathode electrode layer 110 provides mechanical strength for the thin sulfide electrolyte layer to be rolled, handled, and unrolled within an electrode fabrication process. In some examples, the dry process cathode electrode layer 110 has a thickness in a range from approximately 50 μm to approximately 300 μm, (e.g., approximately 200 μm). In some examples, the dry process cathode electrode layer 110 includes or consists of sulfide electrolyte, cathode active material, conductive adhesive, and PTFE binder. In some examples, the sulfide electrolyte includes approximately 10 wt % to 30 wt %, the cathode active material includes approximately 50 wt % to 90 wt %, the conductive additives include approximately 0 wt % to 10 wt %, and the PTFE binder includes approximately greater than 0 wt % and less than or equal to 10 wt % (e.g., greater than 0% and less than 1 wt %). In various implementations, the sum of wt % of the sulfide electrolyte, the cathode active material, the conductive additives, and the PTFE binder equals 100 wt %.

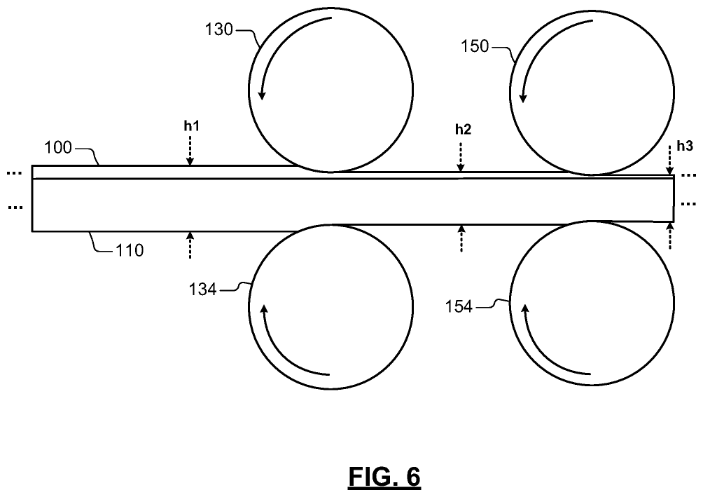

Referring now to FIG. 4, a multi-step calendaring process with decreasing gap is applied to reduce thickness of the PTFE-based sulfide electrolyte layer 100 gradually. In some examples, a higher calendaring temperature (heating) is used to increase the elongate rate of the combination membrane. In some examples, the calendaring temperature is in a range from 25 degrees Celsius (° C.) to 320° C. In some examples, the calendaring temperature is in a range from 80° C. to 150° C.

In FIG. 5, a calendaring process may also be used to reduce the thickness of the dry process cathode electrode layer 110 as well. Then, the PTFE-based sulfide electrolyte layer 100 and the dry process cathode electrode layer 110 can be laminated together, and one or more additional calendaring steps may be performed as shown herein.

Referring back to FIG. 4, a mixture of material for the PTFE-based sulfide electrolyte layer 100 is supplied by a source 310 between rollers 312 and 314. The PTFE-based sulfide electrolyte layer is calendared using multiple steps using multiple sets of rollers. The PTFE-based sulfide electrolyte layer 100 is compressed successively by rollers 320 and 322, rollers 326 and 328, and rollers 330 and 332. A height of the PTFE-based sulfide electrolyte layer 100 is successively reduced from h1, to h2, to h3, and to h4. Examples of h1, h2, h3, and h4 are approximately 400 μm, approximately 200 μm, approximately 100 μm, and approximately 50 μm, respectively, although the present application is also applicable to one or more other heights.

In FIG. 5, a mixture of material for the dry process cathode electrode layer 110 is supplied by a source 360 between rollers 362 and 364. The dry process cathode electrode layer 110 is calendared using multiple steps. The dry process cathode electrode layer 110 is further compressed by one or more pairs of rollers 368 and 370. A height of the dry process cathode electrode layer 110 is successively reduced from H1 to H2. Examples of H1 and H2 are approximately 400 μm and approximately 200 μm, respectively, although the present application is also applicable to one or more other heights.

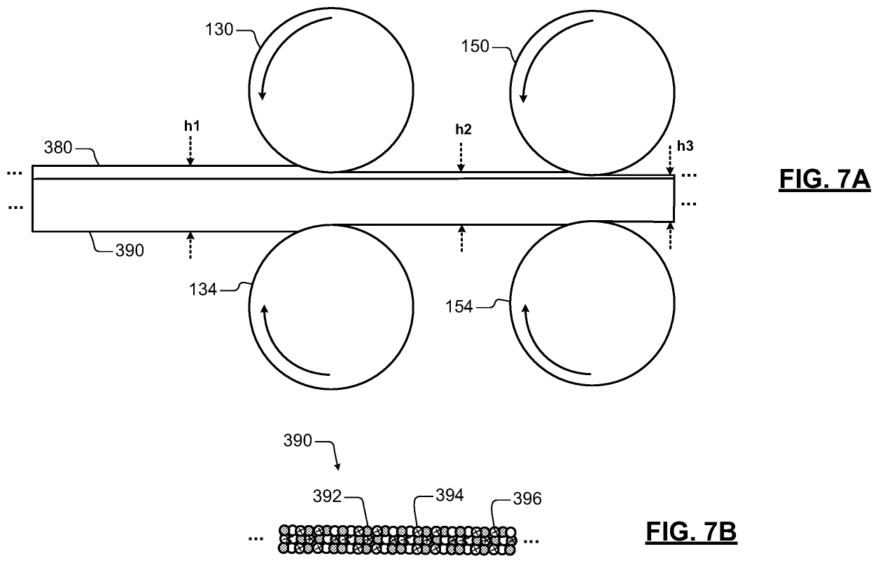

In FIG. 6, the PTFE-based sulfide electrolyte layer and the dry process electrode are calendared using multiple steps and multiple sets of rollers. The PTFE-based sulfide electrolyte layer 100 is arranged in contact with the dry process electrode 110, and the laminate (combination) is compressed by rollers 130 and 134 and then compressed again by rollers 150 and 154. A height h1 is reduced to a height h2 and then to a height h3. For example, h1 is in a range from 200 to 300 μm, h2 is in a range from 150 to 225 μm, and h3 is in a range from 100 to 175 μm. For example, h1=250 μm, h2=175 μm, and h3=125 μm.

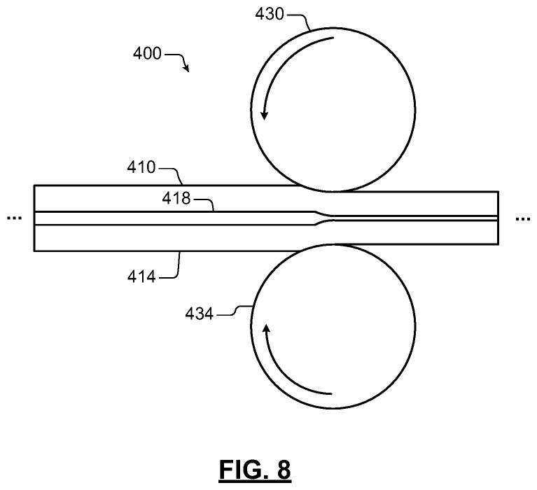

Referring now to FIGS. 7A and 7B, a similar process can be used for a solid electrolyte layer 380 supported by a dry process anode electrode layer 390. The dry process anode electrode layer 390 includes solid electrolyte 392, anode active material 394, and PTFE binder 396.

The solid electrolyte layer 380 builds up favorable ion transfer between cathode and anode electrodes. In some examples, the solid electrolyte layer 380 has a thickness in a range of approximately 2 μm to approximately 30 μm (e.g., approximately 20 μm). The solid electrolyte layer 380 includes or consists of sulfide electrolyte and PTFE binder. In some examples, the sulfide electrolyte is in a range from 90 wt % to 99.9 wt % and the PTFE binder is in a range from 0.1 wt % to 10 wt % (e.g., less than 2 wt %). In various implementations, the sum of wt % of the sulfide electrolyte and the PTFE binder equals 100 wt %.

The dry process anode electrode layer 390 provides mechanical strength for the thin sulfide electrolyte layer 380 to be rolled, handled, and unrolled within an electrode fabrication process. In some examples, a thickness of the dry process anode electrode layer 390 is in a range from approximately 50 μm to approximately 150 μm (e.g., approximately 100 μm).

The dry process anode electrode layer 390 includes sulfide electrolyte, anode active material, conductive additive, and PTFE binder. In some examples, the sulfide electrolyte includes or consists of 10 wt % to 30 wt %, the anode active material comprises 50 wt % to 90 wt %, the conductive additives 0 wt % to 10 wt %, and the PTFE binder comprises greater than 0 wt % and less than or equal to 10 wt % (e.g., less than 1 wt %). In various implementations, the sum of wt % of the sulfide electrolyte, the anode active material, the conductive additives, and the PTFE binder equals 100 wt %.

Referring now to FIG. 8, a method for calendaring a PTFE-based sulfide electrolyte layer 418 arranged between a dry process anode electrode layer 414 and a dry process cathode electrode layer 410 is shown. The dry process cathode electrode layer 410, the PTFE-based sulfide electrolyte layer 418 and the dry process anode electrode layer 414 are compressed by one or more sets of rollers, such as rollers 430 and 434.

In some examples, the dry process cathode electrode layer 410 has a thickness after the calendaring in a range from 50 μm to 300 μm (e.g., 200 μm). The dry process cathode electrode layer 410 may include or consist of sulfide electrolyte, cathode electrode material, conductive additives, and PTFE binder. In some examples, the sulfide electrolyte includes approximately 10 wt % to 30 wt %, the cathode active material includes approximately 50 wt % to 90 wt %, the conductive additives include approximately 0 wt % to 10 wt %, and the PTFE binder includes greater than 0 wt % and less than or equal to 10 wt % (e.g., greater than 0% and less than 1 wt %). In various implementations, the sum of wt % of the sulfide electrolyte, the cathode active material, the conductive additives, and the PTFE binder equals 100 wt %.

The PTFE-based sulfide electrolyte layer 418 builds up favorable ion transfer between cathode and anode electrodes. In some examples, the PTFE-based sulfide electrolyte layer 418 has a thickness in a range from approximately 2 μm to approximately 30 μm (e.g., approximately 20 μm) after the calendaring. In some examples, the PTFE-based sulfide electrolyte layer 418 includes or consists of sulfide electrolyte and PTFE binder. In an example, the sulfide electrolyte may include 90 wt % to 99.9 wt % and the PTFE binders may include 0.1 wt % to 10 wt % (e.g., 2 wt %). In various implementations, the sum of wt % of the sulfide electrolyte and the PTFE binder equals 100 wt %.

In some examples, the dry process anode electrode layer 414 has a thickness after the calendaring in a range from approximately 50 μm to approximately 150 μm (e.g., approximately 100 μm). The dry process anode electrode layer 414 may include a sulfide electrolyte, an anode active material, conductive additives, and PTFE binder. In some examples, the sulfide electrolyte includes or consists of 0 wt % to 30 wt %, the anode active material comprises 50 wt % to 90 wt %, the conductive additives 0 wt % to 10 wt %, and the PTFE binder comprises greater than 0 wt % and less than or equal to 10 wt % (e.g., less than 1 wt %). In various implementations, the sum of wt % of the sulfide electrolyte, the anode active material, the conductive additives, and the PTFE binder equals 100 wt %.

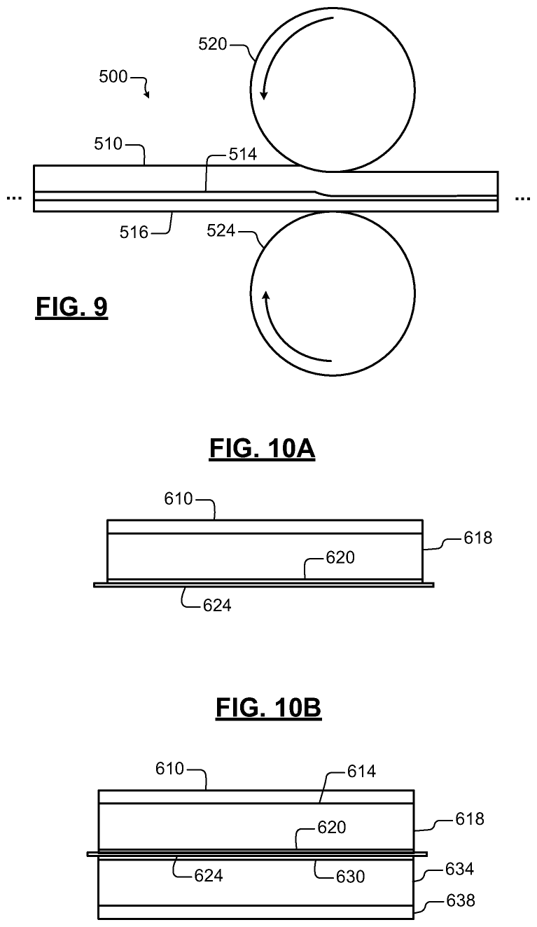

Referring now to FIG. 9, a method 500 for calendaring a PTFE-based sulfide electrolyte layer 514 supported by a dry process electrode 510 and a substrate 516 is shown. The PTFE-based sulfide electrolyte layer 514, the dry process electrode 510, and the substrate 516 are compressed by one or more sets of rollers, such as rollers 520 and 524. The dry process anode electrode layer 414 includes anode active material 420, sulfide electrolyte 422, and PTFE fibrils 424.

The substrate 516 protects and supports the thin sulfide membrane and may have a thickness in a range from approximately 20 μm to approximately 100 μm (e.g., approximately 50 μm), although the present application is also applicable to other thicknesses. In some examples, the substrate comprises polyethylene terephthalate (PET) film.

Referring now to FIGS. 10A and 10B, single and double-sided electrodes are shown. In FIG. 10A, a sulfide electrolyte layer 610 and a dry cathode layer 618 are attached to one side of a current collector 624, such as using conductive adhesive 620. In FIG. 10B, a sulfide electrolyte layer 638 and a dry cathode layer 634 are attached to an opposite side of the current collector 624, such as using conductive adhesive 630.

In some examples, the electrically conductive adhesive layer includes polymer and conductive filler. In some examples, the conductive filler includes a carbon material Super P, carbon black, graphene, carbon nanotubes, carbon nanofibers. In some examples, the conductive filler includes metal powder such as Ag, Ni, or Al. In some examples, the polymer is configured to resist solvent and provide good adhesion. In some examples, the polymer includes epoxy, polyimide (polyamic acid), polyester, vinyl ester, thermoplastic polymers (less solvent resistant) include PVDF, polyamide, silicone, and acrylic. In some examples, a mass ratio of filler/polymer is in a range from approximately 0.1% to approximately 50%, (e.g., SP/PAA=1/3; SWCNT/PVDF=0.2%). In some examples, a thickness of the conductive adhesive is in a range from approximately 0.5 μm to approximately 20 μm.

In some examples, the solid electrolyte is selected from a group including or consisting of pseudobinary sulfide, pseudoternary sulfide, pseudoquaternary sulfide, halide-based solid electrolyte, and hydride-based solid electrolyte. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X═F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X═F, Cl, Br, I) system, 0.4LiI·0.6Li₄SnS₄ and Li₁₁Si₂PS₁₂.

Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂. Examples of halide-based solid electrolyte include LisYCl₆, LisInCl₆, LisYBr₆, LiI, Li₂CdCl₄, Li₂MgCl₄, Li₂CdI₄, Li₂ZnI₄, LisOCl. Examples of hydride-based solid electrolyte include LiBH₄, LiBH₄—LiX (X═Cl, Br, or I), LiNH₂, Li₂NH, LiBH₄-LINH₂, Li₃AlH₆. In other examples, other solid electrolyte that possesses low grain-boundary resistance.

In some examples, the cathode active material is selected from a group including or consisting of rock salt layered oxide, spinel, polyanion cathode materials, lithium transition-metal oxides, and lithiated metal oxide/sulfide. Examples of rock salt layered oxides include LiCoO₂, LiNiₓMn_{y}Co_{1-x-y}O₂, LiNiₓMn_{y}Al_{1-x-y}O₂, LiNiₓMn1-xO2, Li₁₊ₓ MO₂. Examples of spinel include LiMn₂O₄ and LiNi_{0.5}Mn_{1.5}O₄. Examples of polyanion cathode materials include LiV₂(PO₄)₃. Surface-coated and/or doped cathode materials mentioned above can also be used such as LiNbO₃-coated LiMn₂O₄, Li₂ZrO₃ or Li₃PO₄-coated LiNiₓMn_{y}Co_{1-x-y}O₂, and Al-doped LiMn₂O₄. Examples of lithiated metal oxide/sulfide include LiTiS₂), lithium sulfide, and sulfur.

In some examples, the anode active material is selected from a group including or consisting of carbonaceous material (e.g., graphite, hard carbon, soft carbon etc.), silicon, silicon mixed with graphite, Li₄Ti₅O₁₂, transition-metals (e.g., Sn), metal oxide/sulfide (e.g., TiO₂, FeS, etc.), other lithium-accepting anode materials, Li metal and Li alloy.

In some examples, the conductive additive is selected from a group including or consisting of carbon black, graphite, graphene, graphene oxide, Super P, acetylene black, carbon nanofibers, carbon nanotubes and other electronically conductive additives.

In some examples, the PTFE binder has a particle size in a range from approximately 300 um to approximately 800 um. In other examples, other fibrillating polymer binders are used (e.g., fluorinated ethylene propylene (FEP), perfluoroalkoxy (PFA), ethylene tetrafluoroethylene (ETFE), or a combination thereof).

In other examples, a binder polymer with film forming properties and high film elongation is used. In some examples, the binder polymer is selected from a group including or consisting of polyvinylidene fluoride-hexafluoropropylene (polyvinylidene fluoride-co-hexafluoropropylene), polyvinylidene fluoride-trichlorethylene (polyvinylidene fluoride-cotrichlorethylene), polymethylmethacrylate, Polyacrylonitrile, polyvinylpyrrolidone, polyvinylacetate, ethylene-co-vinyl acetate, polyethylene oxide, cellulose acetate, cellulose acetate butyrate, cellulose acetate propionate, cyanoethylpullulan, cyanoethylpolyvinylalcohol, cyanoethylcellulose, cyano Noethyl sucrose (cyanoethylsucrose), pullulan (pullulan), carboxyl methyl cellulose, acrylonitrile-styrene-butadiene copolymer, polyimide or mixtures thereof.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. Approximately as used herein may mean +/−10% of stated values.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for preparing an electrolyte layer supported by a dry process electrode layer, the method comprising:
providing a sulfide electrolyte layer;
providing a first dry process electrode layer;
arranging a first side of the sulfide electrolyte layer adjacent to a first side of the first dry process electrode layer; and
calendaring the sulfide electrolyte layer and the first dry process electrode layer to reduce a thickness of the sulfide electrolyte layer to a predetermined thickness in a range from approximately 5 micrometers (μm) to approximately 50 μm.

2. The method of claim 1, wherein providing the sulfide electrolyte layer comprises:
preparing a mixture of a sulfide electrolyte and polytetrafluoroethylene (PTFE) binder to create the sulfide electrolyte layer; and
calendaring the mixture one or more times to reduce a thickness of the sulfide electrolyte layer.

3. The method of claim 2, wherein the sulfide electrolyte comprises 90 wt % to 99.9 wt % and the PTFE binder comprises 0.1 wt % to 10 wt % of the sulfide electrolyte layer.

4. The method of claim 1, wherein providing the first dry process electrode layer comprises:
preparing a mixture of a sulfide electrolyte, active material, a conductive additive, and PTFE binder to create the sulfide electrolyte layer; and
calendaring the mixture one or more times to reduce a thickness of the first dry process electrode layer.

5. The method of claim 4, wherein the sulfide electrolyte comprises 10 wt % to 30 wt %, the active material comprises 50 wt % to 90 wt %, the conductive additive comprises 0 wt % to 10 wt %, and the PTFE binder comprises greater than 0 wt % and less than or equal to 10 wt % of the dry process electrode layer.

6. The method of claim 5, wherein the active material comprises cathode active material.

7. The method of claim 6, wherein the cathode active material is selected from a group consisting of rock salt layered oxide, spinel, a polyanion cathode material, lithium transition-metal oxides, and lithiated metal oxide/sulfide.

8. The method of claim 5, wherein the active material comprises anode active material.

9. The method of claim 8, wherein the anode active material is selected from a group consisting of carbonaceous material, silicon, silicon and graphite, Li₄Ti₅O₁₂, a transition-metal, metal oxide/sulfide, Li metal, and Li alloy.

10. The method of claim 5, wherein the sulfide electrolyte is selected from a group consisting of pseudobinary sulfide, pseudoternary sulfide, pseudoquaternary sulfide, halide-based solid electrolyte, and hydride-based solid electrolyte.

11. The method of claim 5, wherein the conductive additive is selected from a group consisting of carbon black, graphite, graphene, graphene oxide, Super P, acetylene black, carbon nanofibers, and carbon nanotubes.

12. The method of claim 1, further comprising:
prior to calendaring, arranging a second dry process electrode layer adjacent to a second side of the sulfide electrolyte layer,
wherein the first dry process electrode layer comprises a cathode electrode layer, and
wherein the second dry process electrode layer comprises an anode electrode layer.

13. The method of claim 1, further comprising:
attaching the sulfide electrolyte layer and the first dry process electrode layer to a current collector using an electrically conductive adhesive.

14. The method of claim 13, wherein the electrically conductive adhesive comprises a polymer and an electrically conductive filler.

15. The method of claim 14, wherein the polymer is selected from a group consisting of epoxy, polyimide, polyester, vinyl ester, polyvinylidene fluoride (PVDF), polyamide, silicone, and acrylic.

16. The method of claim 14, wherein the conductive filler is selected from a group consisting of Super P, carbon black, graphene, carbon nanotubes, carbon nanofibers, and metal powder.

17. The method of claim 1, wherein a second side of the sulfide electrolyte layer is arranged on a substrate.

18. The method of claim 17, wherein the substrate comprises polyethylene terephthalate (PET).

19. The method of claim 1, further comprising:
attaching one side of a first one of the first dry process electrode layer and the sulfide electrolyte layer to a first side of a current collector using an electrically conductive adhesive.

20. The method of claim 19, further comprising:
attaching one side of a second one of the first dry process electrode layer and the sulfide electrolyte layer to a second side of the current collector using an electrically conductive adhesive.
